(19) United States
(12) Patent Application Publication
(10) Pub. No.: US 2017/0097816 A1
(43) Pub. Date: Apr. 6, 2017

(54) CONTEXT-BASED APPLICATIONS FOR MOBILE DEVICES

(71) Applicant: Motorola Mobility LLC, Chicago, IL (US)

(72) Inventor: Sharad Joshi, Schaumburg, IL (US)

(21) Appl. No.: 14/872,315

(22) Filed: Oct. 1, 2015

(51) Int. Cl. G06F 9/445; H04L 29/08; H04W 4/00

(52) U.S. Cl. CPC G06F 8/61; H04W 4/003; H04L 67/327; H04L 67/10

(57) ABSTRACT

Determining a present context for a mobile device or a user of the mobile device, obtaining a list of available applications from an online application portal, identifying one or more relevant applications that are relevant to the present context from the list of available applications, providing a user notification that identifies the one or more relevant applications, installing the one or more relevant applications on the mobile device, and de-installing irrelevant applications on the mobile device.

### FIELD OF THE DISCLOSURE

The present disclosure relates generally to applications for mobile devices and, more particularly, to methods and apparatuses for context-based installation and de-installation of applications.

### BACKGROUND OF THE DISCLOSURE

Mobile device users may install a number of different applications on their devices. Some of these applications are suited for a specific context or setting, and are not needed unless the user is in this context. However, context-specific applications persist on the mobile device, irrespective of whether or not such applications are appropriate to the user's present context. Over time, these applications bloat the device, occupying a finite amount of available memory space, while consuming battery power as well as central processing unit (CPU) resources. This may result in a slower mobile device with an undesirably short battery life.

### BRIEF SUMMARY OF THE INVENTION

In at least some embodiments, the present invention relates to a method that includes determining a present context for a mobile device or a user of the mobile device, obtaining a list of available applications from an online application portal, identifying one or more relevant applications that are relevant to the present context from the list of available applications, providing a user notification that identifies the one or more relevant applications, and installing the one or more relevant applications on the mobile device.

According to a set of further embodiments, the method includes prompting the user as to whether or not each of the one or more relevant applications should be installed on the mobile device, receiving a response to the user prompt specifying one or more selected relevant applications that are to be installed on the mobile device, and installing the one or more selected relevant applications on the mobile device. A determination is performed as to whether or not at least one of the mobile device or the user has exited the context. When at least one of the mobile device or the user has exited the context, login information for each of the one or more selected relevant applications, and a set of metadata for each of the one or more selected applications, are stored in a non-transitory computer-readable storage medium on the mobile device. The one or more selected applications are then de-installed from the mobile device.

Additionally, in at least some embodiments, the present invention relates to a mobile device that includes one or more sensors for determining a present context; a communications mechanism, operatively coupled to the one or more sensors, for obtaining a list of available applications from an online application portal; a processing mechanism, operatively coupled to the communications mechanism and the one or more sensors, for identifying one or more relevant applications that are relevant to the present context from the list of available applications; and a display device, operatively coupled to the processing mechanism, for providing a user notification that identifies the one or more relevant applications; wherein the processing mechanism installs the one or more relevant applications on the mobile device.

According to a set of further embodiments, the display device is configured for prompting the user as to whether or not each of the one or more relevant applications should be installed on the mobile device. The processing mechanism receives a response to the user prompt specifying one or more selected relevant applications that are to be installed, and then installs the one or more selected relevant applications on the mobile device. The processing mechanism and the sensors perform a determination as to whether or not at least one of the mobile device or the user has exited the context. When at least one of the mobile device or the user has exited the context, the processing mechanism stores login information for the one or more selected relevant applications, and a set of metadata for the one or more selected relevant applications, in a non-transitory computer-readable storage medium that is operatively coupled to the processing mechanism. The processing mechanism then de-installs the one or more selected relevant applications from the mobile device.

Moreover, in at least some embodiments, the present invention relates to a non-transitory computer readable memory device encoded with a computer program comprising computer readable instructions recorded thereon for execution of a method that includes determining a present context for a mobile device or a user of the mobile device, obtaining a list of available applications from an online application portal, identifying one or more relevant applications that are relevant to the present context from the list of available applications, providing a user notification that identifies the one or more relevant applications, and installing the one or more relevant applications on the mobile device.

According to a set of further embodiments, the non-transitory computer readable memory device further includes instructions for prompting the user as to whether or not each of the one or more relevant applications should be installed on the mobile device, receiving a response to the user prompt specifying one or more selected relevant applications that are to be installed, and installing the one or more selected relevant applications on the mobile device. A determination is performed as to whether or not at least one of the mobile device or the user has exited the context. When at least one of the mobile device or the user has exited the context, login information for each of the one or more selected relevant applications, and a set of metadata for each of the one or more selected applications, are stored in a non-transitory computer-readable storage medium on the mobile device. The one or more selected applications are then de-installed from the mobile device.

### BRIEF DESCRIPTION OF THE DRAWINGS

FIGS. 1A and 1B together comprise a flowchart setting forth an illustrative operational sequence for performing context-based installation and de-installation of applications on a mobile device or a wearable device in accordance with a set of exemplary embodiments.

FIG. 2 is a hardware or software block diagram showing an illustrative context engine on which the operational sequence of FIGS. 1A and 1B may be performed in accordance with a set of exemplary embodiments.

FIG. 3 is a hardware or software block diagram showing an illustrative configuration for determining a present context in accordance with a set of exemplary embodiments.

FIG. 4 is a hardware block diagram showing an illustrative configuration for a sensor input collector in accordance with a set of exemplary embodiments.

FIG. 5 is a hardware block diagram showing an illustrative mobile device for performing context-based installation and de-installation of applications in accordance with a set of exemplary embodiments.

### DETAILED DESCRIPTION

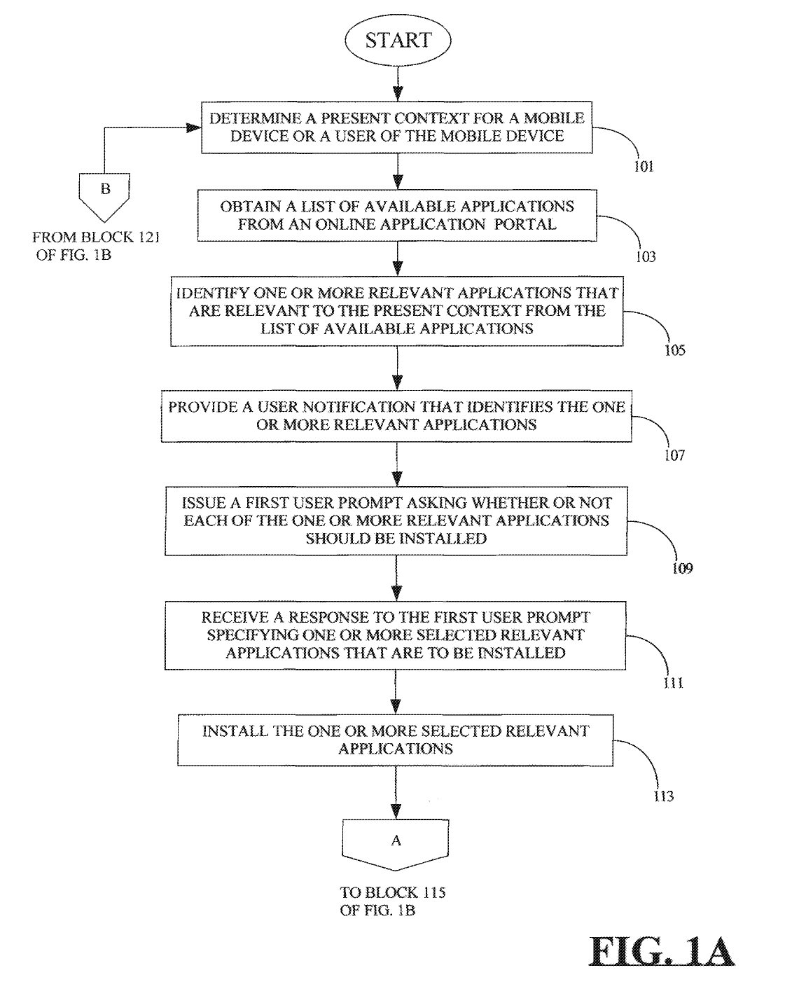

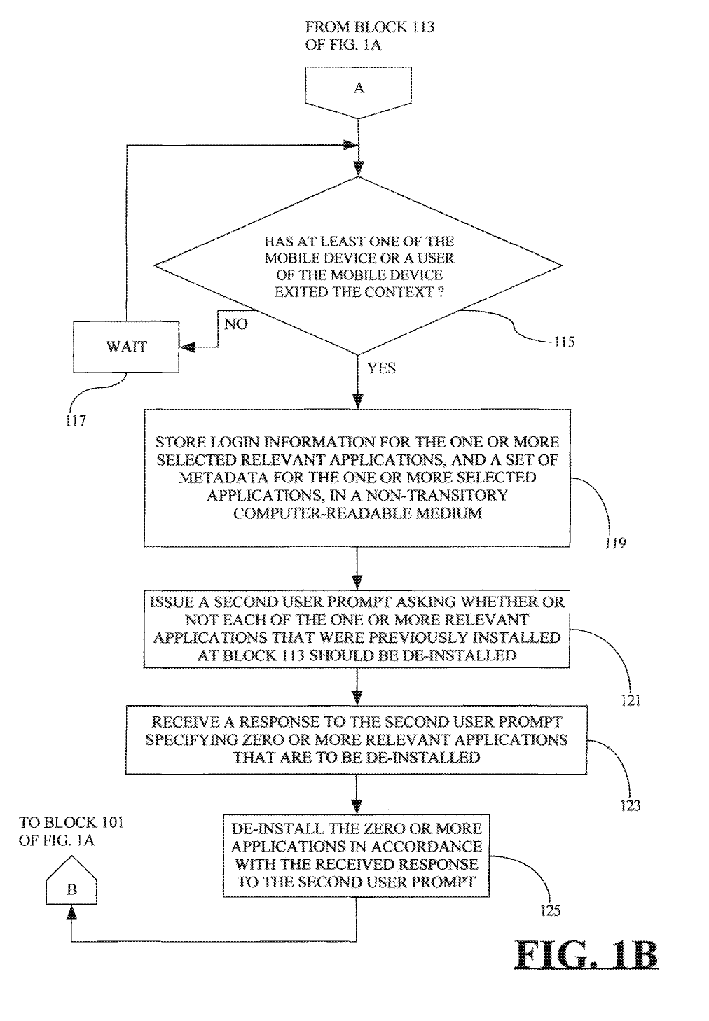

FIGS. 1A and 1B together comprise a flowchart setting forth an illustrative operational sequence for performing context-based installation and de-installation of applications on a mobile device or a wearable device in accordance with a set of exemplary embodiments. The operational sequence commences at block 101 (FIG. 1A) where a present context is determined. A present context may be regarded as a set of circumstances that form a setting in which a mobile device or a mobile device user is presently engaged. For example, a present context could be defined in terms of an activity, or a location, or both, such as jogging outdoors, walking in close proximity to a particular store, or fishing on a lake in the state of Wisconsin. Additionally or alternatively, a present context could be defined in terms of a state or a status, such as a measured heart rate for the mobile device user, a severe weather warning for a geographic area in which the mobile device user is located, or a low battery condition of the mobile device.

The operational sequence progresses to block 103 where a list of available applications is obtained from an online application portal. Illustrative examples of online application portals include the Google Play™ store, the Apple App™ Store, SlideMe™, Camangi™, AppsLib™, Soci.iO™ 1Mobile™, the Nook App Store™ Appoke™, the Tegra Store™, the AmazonAppStore™, MiKandi™, AndroidPit™, AppCity™, Zeewee™, WAC™, OpenAppMarket™, GetJar™, Handmark™, Handster™, and others.

Next, at block 105, one or more relevant applications are identified from the list of available applications that are relevant to the present context. For example, if the present context is outdoor jogging, some illustrative relevant applications may include a weather forecasting application, a heart rate monitoring application, a pedometer application, and a stopwatch application. By comparison, if the present context is shopping at MegaLoMart, then a relevant application may include an application that displays coupons, promotional offerings, and advertisements for various products that are sold at MegaLoMart, as well as an application that displays a user's bank balance or available credit card balance.

At block 107, a user notification is provided that identifies the one or more relevant applications. The user notification may include any of a displayed list of relevant applications, a displayed set of icons each corresponding to a particular relevant application, an audible tone or melody used to signify or identify the one or more relevant applications, a set of audible tones or melodies where each tone or melody corresponds to a particular relevant application, an email or text message notification that includes a list of relevant applications, or any of various other types of user notifications.

According to some embodiments, the one or more relevant applications are automatically installed. According to other embodiments, the relevant applications are not automatically installed, but rather, a first user prompt is issued asking the user whether or not each of the one or more relevant applications should be installed (block 109). Alternatively or additionally, the user may be prompted as to whether or not each of the one or more relevant applications should not be installed.

Next, at block 111, a response to the first user prompt is received that specifies one or more selected relevant applications that are to be installed. The operational sequence progresses to block 113 where the one or more selected relevant applications are installed. However, in embodiments where the relevant applications are installed automatically without issuing any user prompt, then all relevant applications are installed at block 113.

The operational sequence progresses to block 115 (FIG. 1B) where a determination is made as to whether or not at least one of the mobile device or the user has exited the context. If not, the operational sequence waits at block 117 for a predetermined or specified amount of time, after which the determination of block 115 is performed again. When at least one of the mobile device or the user has exited the context, the operational sequence progresses to block 119. Login information for each of the one or more selected relevant applications, as well a set of metadata for each of the one or more selected applications, are stored in a non-transitory computer-readable storage medium. In embodiments where all relevant applications are automatically installed, then block 119 includes storing login information and metadata for all of the relevant applications.

At block 121, a second user prompt is issued asking the user whether or not each of the one or more relevant applications that were previously installed at block 113 should be de-installed. At block 123, a response is received to the second user prompt specifying zero or more relevant applications that are to be de-installed. Next, at block 125, the zero or more applications are de-installed from the mobile device in accordance with the received response to the second user prompt. The operational sequence loops back to block 101 (FIG. 1A). Optionally, blocks 121 and 123 may be skipped, and all of the applications that were previously installed at block 113 are automatically de-installed without user prompting. Pursuant to another embodiment, the prompt of block 121 is replaced with a notification indicating that all of the applications that were previously installed at block 113 are now going to be automatically de-installed, and the notification optionally identifies each of the applications that are going to be de-installed. Additionally or alternatively, separate prompts or notifications may be provided for each of the applications that may be de-installed, whereupon the user may elect de-installation of all, some, or none of the applications.

The aforementioned operational sequence of FIGS. 1A and 1B merely provides a set of illustrative examples that are intended to be encompassed by the present disclosure. By way of example, FIGS. 1A and 1B may, but need not, be utilized to implement a procedure for renting or leasing applications for a mobile device or a wearable device. The present disclosure is intended to encompass numerous other manners of operation in addition to those specifically described previously. Numerous other examples of operation in accordance with the processes of FIGS. 1A and 1B, or variations of these processes, can be envisioned and are encompassed herein.

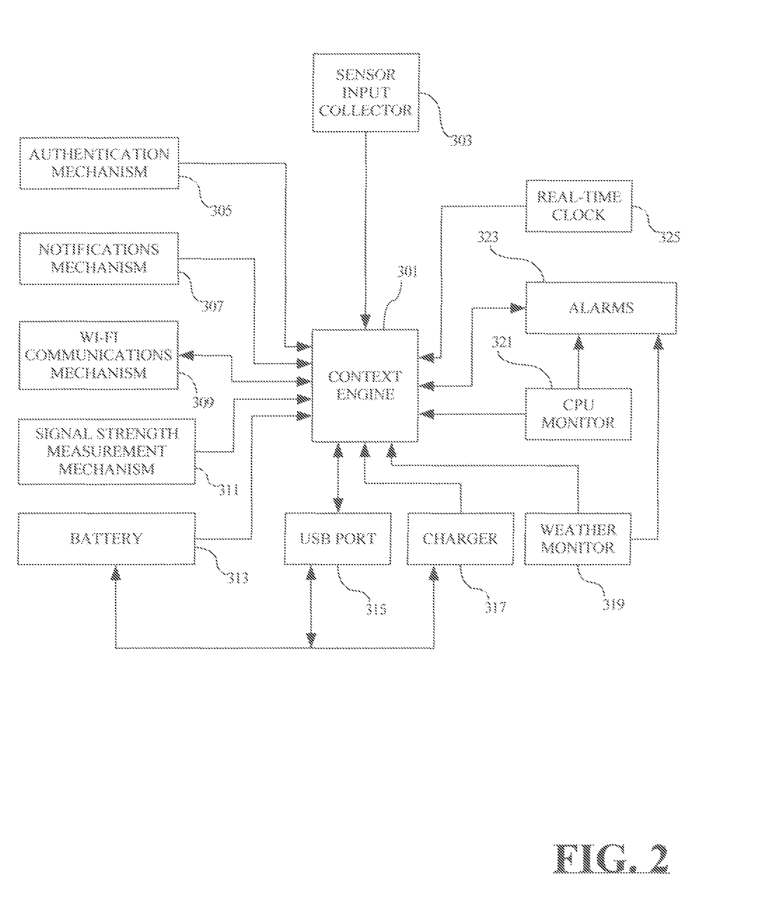

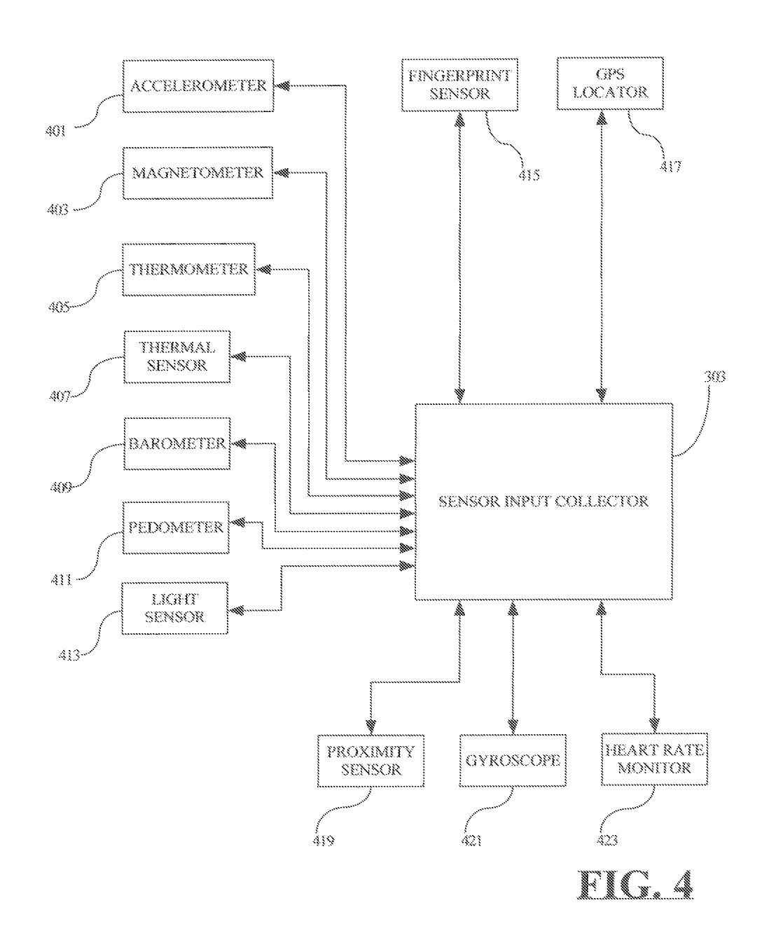

FIG. 2 is a hardware or software block diagram showing an illustrative context engine 301 on which the operational sequence of FIGS. 1A and 1B may be performed in accordance with a set of exemplary embodiments. Any of the blocks shown in FIG. 2 may represent software, or hardware, or a combination of software and hardware. The context engine 301 includes a processing mechanism, such as a microprocessor, a microcomputer, or an application-specific integrated circuit. The processing mechanism is operatively coupled to a non-transitory computer-readable memory device. The context engine 301 receives one or more inputs from a sensor input collector 303, to be described in greater detail hereinafter with reference to FIG. 4.

Returning to FIG. 2, the context engine 301 is powered by a source of electrical energy such as a battery 313. The battery 313 is a device that converts stored chemical energy into electrical energy. The battery 313 is charged by a charger 317 which is illustratively implemented using a power supply. A real-time clock 325 provides a time reference to the context engine 301. This time reference may include information pertaining to the current time of day and the current day of the week, either or both of which may be used to determine the present context at block 101 of FIG. 1A. For example, the real-time clock 325 may be utilized in conjunction with a sunrise-sunset table stored in the context engine 301 to enable a determination as to whether the present context is daylight or nighttime. Likewise, the real-time clock 325 may illustratively be used to determine the present context in terms of whether the current day is a working day, versus a weekend day or a holiday.

The context engine 301 is operatively coupled to an authentication mechanism 305. The authentication mechanism 305 implements a process by which a first set of credentials, as received from a user, are compared to a second set of credentials stored in the context engine 301 in a database of authorized user information. If the first set of credentials matches the second set of credentials, as determined by the context engine, the authentication process is completed and the user is granted authorization for access. Alternatively or additionally, the authentication mechanism 305 may be configured to implement an automatic authentication process.

The context engine 301 is operatively coupled to a notifications mechanism 307. The notifications mechanism 307 is configured for providing notifications in the form of a list of relevant applications for display on a display device, a set of icons each corresponding to a particular relevant application, an audible tone or melody used to signify or identify the one or more relevant applications, a set of audible tones or melodies where each tone or melody corresponds to a particular relevant application, an email or text message notification that includes a list of relevant applications, or any of various other types of user notifications.

The context engine 301 is configured for sending and receiving information over a Wi-Fi communications mechanism 309. Wi-Fi is a local area wireless computer networking technology that allows electronic devices to network using one or both of the 2.4 GHz and 5 GHz industrial, scientific and medical (ISM) radio bands. Wi-Fi is a trademark of a non-profit organization known as the Wi-Fi Alliance. The Wi-Fi Alliance defines Wi-Fi as any wireless local area network (WLAN) product based on the Institute of Electrical and Electronics Engineers (IEEE) 802.11 family of standards. Many computing devices can use Wi-Fi, including personal computers, video-game consoles, smartphones, digital cameras, tablet computers, and digital audio players. Any of these devices can connect to a network resource such as the Internet via a wireless network access point. Such an access point (or hotspot) has a range of approximately 20 meters (66 feet) indoors and a somewhat greater range outdoors. Hotspot coverage can be as small as a single room with walls that block radio waves, or as large as many square miles as achieved by using multiple overlapping access points.

The process of determining a present context in block 101 of FIG. 1A may be performed by determining whether or not a mobile device is within range of a given Wi-Fi hotspot using the Wi-Fi communications mechanism 309. For purposes of illustration, a Wi-Fi hotspot may be provided by or associated with a store, a place of business, or another setting such as a gym or library. A mobile device user is able to connect to this Wi-Fi hotspot only when the user is within a relatively close proximity to the store, place of business, or other setting.

The context engine 301 is operatively coupled to a signal strength measurement mechanism 311 which may be implemented using a relative received signal strength (RSSI) circuit. From a physical standpoint, RSSI is an indication of the power level being received by an antenna. In an IEEE 802.11-compliant system, RSSI is the relative received signal strength, provided in the form of arbitrary units. The 802.11 standard does not define any relationship between RSSI value and received power level in mW or dBm. Vendors and chipset makers provide their own accuracy, granularity, and range for the actual power (measured as mW or dBm) and their range of RSSI values (from 0 to RSSI Max). Therefore, the higher the RSSI number, the stronger the signal.

RSSI can be used to perform coarse-grained estimates of location for a mobile device. These coarse-grained estimates may be employed to determine a context for a mobile device user. Alternatively or additionally, RSSI may be used by the Wi-Fi communications mechanism 309 to determine when the amount of radio energy in a given channel is below a certain threshold, at which point the Wi-Fi communications mechanism 309 is clear to send (CTS). Once the Wi-Fi communications mechanism 309 is clear to send, a packet of information can be sent over a 2.4-GHz or 5-GHz Wi-Fi communications link.

The context engine 301 is configured for sending and receiving information over a universal serial bus (USB) port 315. USB is an industry standard developed by the non-profit USB Implementers Forum that defines the cables, connectors and communications protocols used in a bus for providing connection, communication, and power supply functionality between a first electronic device and a second electronic device. Alternatively or additionally, USB may be used to implement a connection between a power supply and the battery 313 for purposes of charging the battery.

USB provides a standardized connection between computing devices and computer peripherals, to communicate and to supply electric power. Some illustrative examples of computing devices include laptops, tablets, desktop personal computers, video game consoles, personal digital assistants (PDAs) and smartphones. Likewise, some illustrative examples of peripherals include keyboards, pointing devices, tracking balls, digital cameras, printers, portable media players, data storage drives, thumb drives, memory sticks, and network adapters. USB has effectively replaced a variety of earlier interfaces, such as serial and parallel ports, as well as obviated the requirement for separate power chargers for portable devices.

The context engine 301 is operatively coupled to a CPU monitor 321 and a weather monitor 319. The CPU monitor tracks the operational status of the processing mechanism of the context engine 301. For example, if the CPU monitor 321 determines that the processing mechanism of the context engine 301 is hanging, locked up, or frozen, then the CPU monitor 321 may trigger one or more alarms 323. Likewise, if the processing mechanism of the context engine 301 is operating normally, the context engine 301 may trigger one or more of the alarms 323 in response to the context engine 301 receiving input regarding current or expected weather conditions from the weather monitor 319.

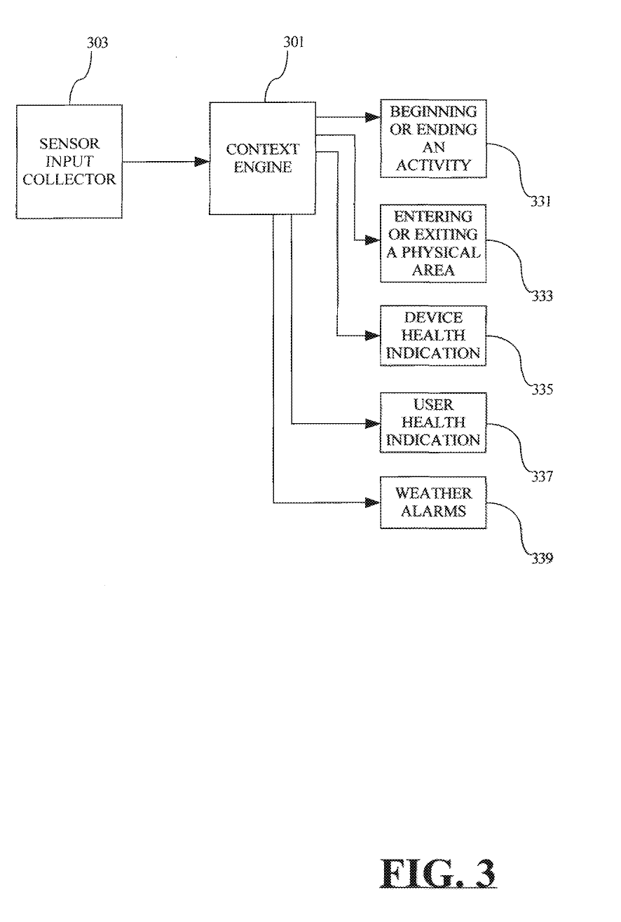

FIG. 3 is a block diagram showing an illustrative hardware or software configuration for determining a present context in accordance with a set of exemplary embodiments. Any of the blocks shown in FIG. 3 may represent software, or hardware, or a combination of software and hardware. The context engine 301 (FIGS. 2 and 3) receives one or more inputs from the sensor input collector 303. The context engine 301 uses the one or more inputs to determine a present context as specified at block 101 of FIG. 1A. For example, the present context may comprise any of a beginning or an ending of an activity 331 (FIG. 3), an entry into or exit from a physical area 333, a device health indication 335, a user health indication 337, or one or more weather alarms 339. The beginning or ending of an activity 331 illustratively comprises beginning or ending an afternoon jogging session, beginning or ending a shopping trip, beginning or ending piano lessons, or beginning or ending work at a place of employment. The entering or exiting of a physical area 333 illustratively includes entering or exiting a gym, a place of employment, a shopping center, a library, a business, a city, a state, a county, or an international boundary. The device health indication 335 illustratively comprises information regarding a charging status for the battery 313 (FIG. 2), as well as the operational status of the context engine 301 (FIGS. 2 and 3). The user health indication 337 (FIG. 3) illustratively comprises information regarding a user's physical health, such as current heart rate, body temperature, or blood pressure.

A set of weather alarms 339 is illustratively triggered in response to current or expected weather conditions, such as temperatures that are above or below a specified threshold, approaching rain or snowstorms, or approaching hurricanes or tornadoes. For example, if the current context is determined to be an afternoon outdoor jogging session, the weather alarms 339 may be triggered or set if the temperature is predicted to exceed 84 degrees with a relative humidity in excess of 95%. Alternatively or additionally, the weather alarms 339 may be triggered or set in response to the actual sensed temperature and humidity as received from the sensor input collector 303 exceeding the aforementioned values.

FIG. 4 is a hardware block diagram showing an illustrative configuration for the sensor input collector 303 in accordance with a set of exemplary embodiments. The sensor input collector 303 collects inputs from one or more sensors. The specific sensors shown in FIG. 4 are for purposes of illustration, as in some embodiments, not all of these sensors need to be employed. Moreover, in other embodiments, sensors in addition to those shown in FIG. 4 may be used.

In the example of FIG. 4, the sensor input collector 303 collects inputs from a plurality of sensors including an accelerometer 401 for measuring an acceleration of a mobile device, and a magnetometer 403 for measuring ambient magnetic fields surrounding the mobile device. The magnetometer 403 comprises a measurement instrument used for any of two general purposes: to measure the magnetization of a magnetic material like a ferromagnet, or to measure the strength and, in some cases, the direction of the magnetic field at a point in space. The direction of the magnetic field may be used as a compass to determine a direction in which a mobile device is oriented, or a direction in which the mobile device is moving.

The plurality of sensors also includes a thermometer 405 for measuring an ambient temperature surrounding the mobile device, a thermal sensor 407 for measuring thermal dissipation of one or more components of the mobile device, a barometer 409 for measuring barometric pressure surrounding the mobile device, a pedometer 411 for sensing steps taken by a user of the mobile device, a light sensor 413 for determining ambient light levels in the vicinity of the mobile device, a fingerprint sensor 415 for identifying and authenticating authorized mobile device users, a GPS locator 417 for determining a current geographic location for the mobile device, a proximity sensor 419 for determining whether or not a user is located in close proximity to the mobile device, a gyroscope 421 for detecting motion of the mobile device, and a heart rate monitor 423 for monitoring a heart rate of a mobile device user.

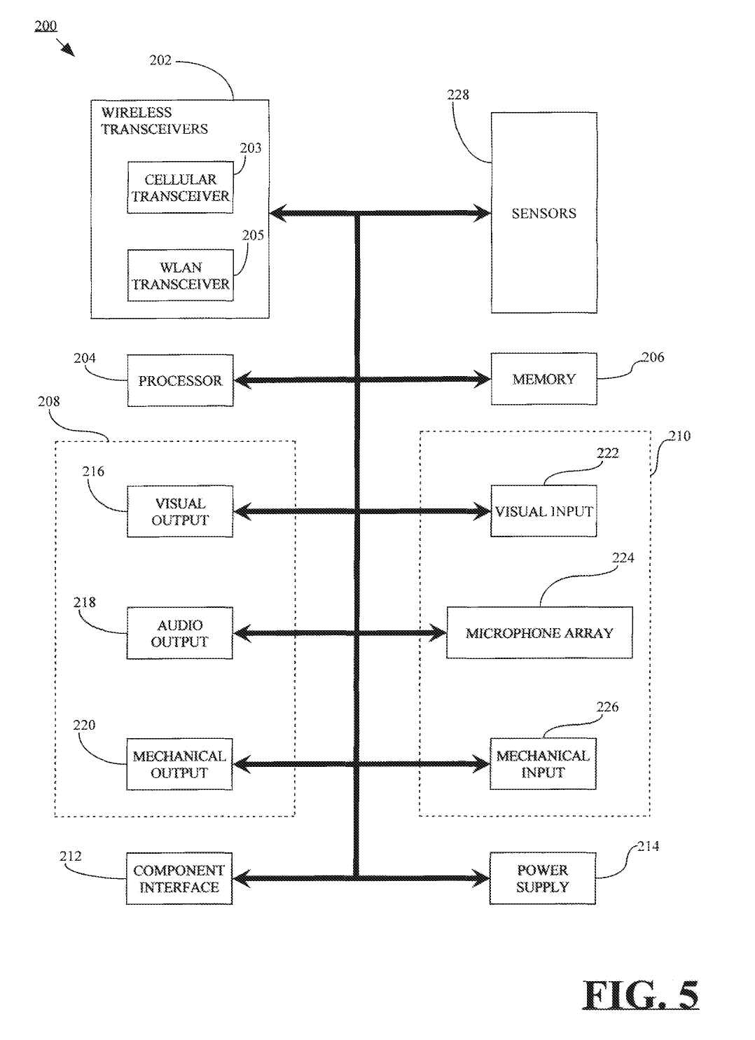

FIG. 5 is a hardware block diagram showing an illustrative mobile device 200 for performing context-based installation and de-installation of applications in accordance with a set of exemplary embodiments. The mobile device 200 is representative of any communication device that is operated by persons (or users) or possibly by other entities (e.g., other computers) desiring or requiring communication capabilities. In some embodiments, for example, the mobile device 200 may be any of a smartphone, a cellular telephone, a personal digital assistants (PDA), another type of handheld or portable electronic device, a headset, an MP3 player, a battery-powered device, a wearable device, a wristwatch, a radio, a navigation device, a laptop or notebook computer, a netbook, a pager, a PMP (personal media player), a DVR (digital video recorder), a gaming device, a game interface, a camera, an e-reader, an e-book, a tablet device, a navigation device with a video-capable screen, a multimedia docking stations, or another type of electronic mobile device.

As shown in FIG. 5, the illustrative mobile device 200 includes one or more wireless transceivers 202, a processor 204 (e.g., a microprocessor, microcomputer, application-specific integrated circuit, etc.), a memory 206, one or more output devices 208, and one or more input devices 210. The processor 204 may be configured to implement the context engine 301 shown in FIGS. 2-3. In at least some embodiments, a user interface is present that comprises one or more output devices 208, such as a display, and one or more input devices 210, such as a keypad or touch sensor. The mobile device 200 can further include a component interface 212 to provide a direct connection to auxiliary components or accessories for additional or enhanced functionality. The mobile device 200 preferably also includes a power supply 214, such as a battery 313 as shown in FIG. 2, for providing power to the other internal components while enabling the mobile device to be portable. Some or all of the components of the mobile device 200 can be coupled to one another, and in communication with one another, by way of one or more internal communication links 232 (e.g., an internal bus).

In the present embodiment of FIG. 5, the wireless transceivers 202 particularly include a cellular transceiver 203 and a wireless local area network (WLAN) transceiver 205. More particularly, the cellular transceiver 203 is configured to conduct cellular communications, such as 3G, 4G, 4G-LTE, etc., vis-à-vis cell towers (not shown), albeit in other embodiments, the cellular transceiver 203 can be configured instead or additionally to utilize any of a variety of other cellular-based communication technologies such as analog communications (using AMPS), digital communications (using CDMA, TDMA, GSM, iDEN, GPRS, EDGE, etc.), and/or next generation communications (using UMTS, WCDMA, LTE, IEEE 802.16, etc.) or variants thereof.

The WLAN transceiver 205 may, but need not, be configured to conduct Wi-Fi communications in accordance with the IEEE 802.11 (a, b, g, or n) standard with access points. In other embodiments, the WLAN transceiver 205 can instead (or in addition) conduct other types of communications commonly understood as being encompassed within Wi-Fi communications such as some types of peer-to-peer (e.g., Wi-Fi Peer-to-Peer) communications. Further, in other embodiments, the WLAN transceiver 205 can be replaced or supplemented with one or more other wireless transceivers configured for non-cellular wireless communications including, for example, wireless transceivers employing ad hoc communication technologies such as HomeRF (radio frequency), Home Node B (3G femtocell), Bluetooth and/or other wireless communication technologies such as infrared technology. Thus, although in the present embodiment the mobile device 108 has two of the wireless transceivers 203 and 205, the present disclosure is intended to encompass numerous embodiments in which any arbitrary number of (e.g., more than two) wireless transceivers employing any arbitrary number of (e.g., two or more) communication technologies are present.

Exemplary operation of the wireless transceivers 202 in conjunction with others of the internal components of the mobile device 200 can take a variety of forms and can include, for example, operation in which, upon reception of wireless signals, the internal components detect communication signals and the transceiver 202 demodulates the communication signals to recover incoming information, such as voice and/or data, transmitted by the wireless signals. After receiving the incoming information from the transceiver 202, the processor 204 formats the incoming information for the one or more output devices 208. Likewise, for transmission of wireless signals, the processor 204 formats outgoing information, which may or may not be activated by the input devices 210, and conveys the outgoing information to one or more of the wireless transceivers 202 for modulation to communication signals. The wireless transceiver(s) 202 convey the modulated signals by way of wireless and (possibly wired as well) communication links to other devices such as a server and one or more content provider websites (as well as possibly to other devices such as a cell tower, access point, or another server or any of a variety of remote devices).

Depending upon the embodiment, the mobile device 200 may be equipped with one or more input devices 210, or one or more output devices 208, or any of various combinations of input devices 210 and output devices 208. The input and output devices 208, 210 can include a variety of visual, audio and/or mechanical outputs. For example, the output device(s) 208 can include one or more visual output devices 216 such as a liquid crystal display and light emitting diode indicator, one or more audio output devices 218 such as a speaker, alarm and/or buzzer, and/or one or more mechanical output devices 220 such as a vibrating mechanism. The visual output devices 216 can include, among other things, a video screen.

In addition, by example, the input devices 210 (FIG. 5) may include one or more sensors 228, or one or more audio input devices 224 such as a microphone, or more mechanical input devices 226 such as a flip sensor, keyboard, keypad, selection button, navigation cluster, touch pad, touchscreen, capacitive sensor, motion sensor, and switch. Actions that can actuate one or more of the input devices 210 can include not only the physical pressing/actuation of buttons or other actuators, but can also include, for example, opening the mobile device 200 (if the device can take on open or closed positions), unlocking the device, moving the device to actuate a motion, moving the device to actuate a location positioning system, and operating the device.

The mobile device 200 includes one or more of various types of sensors 228. The sensors 228 can include any of the sensors described previously in conjunction with FIG. 4. The sensors 228 (FIG. 5) can include, for example, the proximity sensor 419 (FIG. 4) which may be provided in the form of a light detecting sensor, an ultrasound transceiver or an infrared transceiver, or a touch sensor. The sensors 228 (FIG. 5) may also include the barometer 409 (FIG. 4) which may be configured to determine a current altitude for the mobile device 200. The sensors 228 (FIG. 5) may also include the Global Positioning System (GPS) locator 417 (FIG. 4), a triangulation receiver for receiving signals from two or more radio frequency beacons, the accelerometer 401, a tilt sensor, the gyroscope 421, or any other information collecting device that can identify a current location or user-device interface (carry mode) of the mobile device 200 (FIG. 5). Although the sensors 228 are for the purposes of FIG. 5 considered to be distinct from the input devices 210, in other embodiments it is possible that one or more of the input devices 210 can also be considered to constitute one or more of the sensors 228 (and vice-versa).

Additionally, even though in the present embodiment the input devices 210 are shown to be distinct from the output devices 208, it should be recognized that in some embodiments one or more devices serve both as input device(s) and output device(s). For example, in embodiments where a touchscreen is employed, the touchscreen can be considered to constitute both a visual output device and a mechanical input device.

The memory 206 of the mobile device 200 can encompass one or more memory devices of any of a variety of forms (e.g., read-only memory, random access memory, static random access memory, dynamic random access memory, etc.), and can be used by the processor 204 to store and retrieve data. In some embodiments, the memory 206 can be integrated with the processor 204 in a single device (e.g., a processing device including memory or processor-in-memory (PIM)), albeit such a single device will still typically have distinct portions/sections that perform the different processing and memory functions and that can be considered separate devices.

The data that is stored by the memory 206 can include, but need not be limited to, operating systems, applications, and informational data, such as a database. Each operating system includes executable code that controls basic functions of the communication device, such as interaction among the various components included among the mobile device 200, communication with external devices via the wireless transceivers 202 and/or the component interface 212, and storage and retrieval of applications and data, to and from the memory 206.

In addition, the memory 206 can include one or more applications for execution by the processor 204. One such application is the operational sequence described previously in connection with FIGS. 1A and 1B. Each application can include executable code that utilizes an operating system to provide more specific functionality for the communication devices, such as file system service and the handling of protected and unprotected data stored in the memory 206 (FIG. 5). Informational data is non-executable code or information that can be referenced and/or manipulated by an operating system or application for performing functions of the communication device. One such application is a client application which is stored in the memory 206 and configured for performing the methods described herein.

The client application is intended to be representative of any of a variety of client applications that can perform the same or similar functions on any of various types of mobile devices, such as mobile phones, tablets, laptops, etc. The client application is a software-based application that operates on the processor 204 (FIG. 5) and is configured to provide an interface between one or more input devices 210, or one or more output devices 208, or any of various combinations thereof. In addition, the client application governs operation of one or more of the input and output devices 210, 208. Further, the client application may be configured to work in conjunction with a visual interface, such as a display screen, that allows a user of the mobile device 200 to initiate various actions. The client application can take any of numerous forms and, depending on the embodiment, be configured to operate on, and communicate with, various operating systems and devices. It is to be understood that various processes described herein as performed by the mobile device 200, such as the operational sequence of FIGS. 1A and 1B, can be performed in accordance with operation of the client application in particular, and/or other application(s), depending on the embodiment.

It should be appreciated that one or more embodiment encompassed by the present disclosure are advantageous in one or more respects. Thus, it is specifically intended that the present disclosure not be limited to the embodiments and illustrations contained herein, but include modified forms of those embodiments including portions of the embodiments and combinations of elements of different embodiments as come within the scope of the following claims.

What is claimed is:

1. A method comprising:
determining a present context for a mobile device or a user of the mobile device;
obtaining a list of available applications from an online application portal;
identifying one or more relevant applications that are relevant to the present context from the list of available applications;
providing a user notification that identifies the one or more relevant applications; and
installing the one or more relevant applications on the mobile device.

2. The method of claim 1 further comprising prompting the user as to whether or not each of the one or more relevant applications should be installed on the mobile device.

3. The method of claim 2 further comprising receiving a response to the user prompt specifying one or more selected relevant applications that are to be installed on the mobile device.

4. The method of claim 3 further comprising installing the one or more selected relevant applications on the mobile device.

5. The method of claim 1 further comprising performing a determination as to whether or not at least one of the mobile device or the user has exited the context.

6. The method of claim 5 wherein, in response to at least one of the mobile device or the user having exited the context, login information for each of the one or more selected relevant applications, and a set of metadata for each of the one or more selected applications, are stored in a non-transitory computer-readable storage medium.

7. The method of claim 6 further comprising de-installing the one or more selected applications from the mobile device.

8. A mobile device comprising:
one or more sensors for determining a present context for the mobile device or a user of the mobile device;
a communications mechanism, operatively coupled to the one or more sensors, for obtaining a list of available applications from an online application portal;
a processing mechanism, operatively coupled to the communications mechanism and the one or more sensors, for identifying one or more relevant applications that are relevant to the present context from the list of available applications; and
a display device, operatively coupled to the processing mechanism, for providing a user notification that identifies the one or more relevant applications;
wherein the processing mechanism installs the one or more relevant applications on the mobile device.

9. The mobile device of claim 8 wherein the display device is further configured for prompting the user as to whether or not each of the one or more relevant applications should be installed on the mobile device.

10. The mobile device of claim 9 wherein the processing mechanism is further configured for receiving a response to the user prompt specifying one or more selected relevant applications that are to be installed.

11. The mobile device of claim 10 wherein the processing mechanism is further configured for installing the one or more selected relevant applications on the mobile device.

12. The mobile device of claim 11 wherein the processing mechanism and the sensors are further configured for performing a determination as to whether or not at least one of the mobile device or the user has exited the context.

13. The mobile device of claim 12 wherein, in response to at least one of the mobile device or the user having exited the context, the processing mechanism is further configured for storing login information for the one or more selected relevant applications, and a set of metadata for the one or more selected relevant applications, in a non-transitory computer-readable storage medium that is operatively coupled to the processing mechanism.

14. The mobile device of claim 13 wherein the processing mechanism is further configured for de-installing the one or more selected relevant applications from the mobile device.

15. A non-transitory computer readable memory encoded with a computer program comprising computer readable instructions recorded thereon for execution of a method that includes:
determining a present context for a mobile device or a user of the mobile device;
obtaining a list of available applications from an online application portal;
identifying one or more relevant applications that are relevant to the present context from the list of available applications;
providing a user notification that identifies the one or more relevant applications; and
installing the one or more relevant applications on the mobile device.

16. The non-transitory computer readable memory of claim 15 further comprising instructions for prompting the user as to whether or not each of the one or more relevant applications should be installed on the mobile device.

17. The non-transitory computer readable memory of claim 16 further comprising instructions for receiving a response to the user prompt specifying one or more selected relevant applications that are to be installed on the mobile device.

18. The non-transitory computer readable memory of claim 17 further comprising instructions for installing the one or more selected relevant applications on the mobile device.

19. The non-transitory computer readable memory of claim 15 further comprising instructions for performing a determination as to whether or not at least one of the mobile device or the user has exited the context.

20. The non-transitory computer readable memory of claim 19 further comprising instructions wherein, in response to at least one of the mobile device or the user having exited the context, login information for each of the one or more selected relevant applications, and a set of metadata for each of the one or more selected applications, are stored in a non-transitory computer-readable storage medium.
